(19) United States
(12) Patent Application Publication
(10) Pub. No.: US 2023/0237416 A1
(43) Pub. Date: Jul. 27, 2023

(54) SYSTEM AND METHOD FOR ASSESSING WORK HABITS AND PROVIDING RELEVANT SUPPORT

(71) Applicants: RYAN FRANCIS MORRISSEY, WHITE SALMON, WA (US); Megan Irene Myers Irene Myers, Morgan Hill, CA (US); Constantin Ciprian Chifor, Cluj-Napoca (RO)

(72) Inventors: RYAN FRANCIS MORRISSEY, WHITE SALMON, WA (US); Megan Irene Myers Irene Myers, Morgan Hill, CA (US); Constantin Ciprian Chifor, Cluj-Napoca (RO)

(21) Appl. No.: 17/585,543

(22) Filed: Jan. 26, 2022

(51) Int. Cl. G06Q 10/06

(52) U.S. Cl. CPC G06Q 10/06398

(57) ABSTRACT

Employee locations, behavior, language use, emotional expressiveness, and movements are observed by an AI system and network to a communication network to modify, preempt, and mitigate behavior anticipated by an AI model of employee behavior. A system includes a plurality of computational devices and sensors accessed and configured to determine, through one or more networks, a location and behavior of a person and/or a context of the person at documented times and location to predict and evaluate user behavior. An employee's responses to a human psychometric analysis test or personality analysis tool are input to an AI model, as well as written, verbal and visual communications, whereupon the AI model is informed and further trained to consider indications of the employee's (1.) cognitive style, and (2.) behavioral and/or cognitive strengths, preferences and traits as derived from an analysis of employee's responses to the psychometric analysis test or personality analysis tool.

### FIELD OF THE INVENTION

The field of the invention is productivity and management software, specifically a computer-enabled system and method for monitoring performance of an employee and providing targeted assistance for improving the employee's performance.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Every employee on a work project team may have different strengths and weaknesses. For instance, there might be that person who comes up with great ideas but gets sidetracked, or another team member who gets so focused on what they're doing that the team member ends up being late to meetings. A good manager might be able to gently intervene and provide individual solutions to help each of these hypothetical employees perform better in their role. On the other hand, a poor manager might just get frustrated with these employees for going off-task or missing meetings, or try to impose a one-size-fits-all solution, which may produce an outcome that benefits nobody—not the manager or the company, and not the employees. Not every manager is good at managing, and studies show that having a bad boss is among the top reasons people generally give for wanting to quit their job. And yet, the quality of management leadership still varies broadly in the workforce, leaving overwhelmed or underprepared managers scrambling and employees just trying to do their jobs and hoping for the best.

So much of a manager's role remains entirely dependent on the skill and subjective perspective of the individual manager, with little assistance, while automation and technology have eased similar specialization burdens in many other professions. An example of that might include more sophisticated tools for use in construction, substantially reducing the amount of physical strength, specialized knowledge (i.e. lifelong craftsmanship), and risk of injury required to complete a building project at a high standard of quality. Others might include tools and software for performing calculations, when the first space missions relied on the genius precision of human calculators, or even something as humble and ubiquitous as the spell-checker, an artificial aid to everyone's spelling ability.

Therefore, there is a long-standing need to provide managers and the employees they manage with supportive tools for enhancing or standardizing the art of management, which comprehensively assess employee performance and provide employees with constructive support to improve their performance in their roles.

### SUMMARY OF THE INVENTION

Towards these and other objects of the method of the present invention (hereinafter, “the invented method”) that are made obvious to one of ordinary skill in the art in light of the present disclosure, what is provided is a system and method for monitoring employee performance and providing strategic intervention to develop employee performance.

In certain preferred embodiments of the invention, employee locations, behavior, language use, emotional expressiveness, and movements, are observed by an AI system and network to a communication network to modify, preempt, and mitigate behavior anticipated by an AI model of employee behavior. A system includes a plurality of computational and communications devices and sensors accessed and configured to determine, through one or more communications networks, a location and behavior of a person and/or a context of the person at documented times and location to predict and evaluate user behavior. An employee's responses to a human psychometric analysis test or personality analysis tool are input to an AI model, as well as written, verbal and visual communications, whereupon the AI model is informed and further trained to consider indications of the employee's (1.) cognitive style, and (2.) behavioral and/or cognitive strengths, preferences and traits as derived from an analysis of the employee's responses to said human psychometric analysis test or personality analysis tool.

In certain additional alternate embodiments of the invented system and method, in an office where work is generally done on computers, such as a corporate office, one or more employees' performance might be tracked and monitored such as but not limited to by recording work-related communications, tracking meeting attendance, tracking usage of the employee's devices, and asking the employee to complete questionnaires such as aptitude tests or personality quizzes.

From this data, an Artificial Intelligence (“AI”) model might be informed or trained, such that the AI model might assist in management of the employee(s) by making useful analyses, assessments, and predictions about an employee's performance or optimal career path, and suggesting areas for improvement and methods to support each employee in improving their work habits. The AI might further recommend or generate strategically-implemented cues to support the employee(s) in known areas of difficulty, such as providing alarms to get to meetings on time or visual displays as reminders.

In certain other alternate embodiments of the invented method, an employee's responses provided by the employee in the completion or engagement with a human psychometric analysis test or personality analysis tool are input to the AI model, whereupon the AI model is informed and further trained to consider indications of the employee's (1.) cognitive style, and (2.) behavioral and/or cognitive strengths, preferences and traits as derived from an analysis of the employees responses to said human psychometric analysis test or personality analysis tool.

In certain still other alternate embodiments of the invented method, a manager might access an AI model evaluation pertaining to an employee the manager is managing, as a tool to assist in managing that employee. For instance, the AI model's assessment might be accessed to inform an upcoming performance review, or figure out which employees to send to a training seminar with limited seats. In addition to collating data about the employee's work and personality, the AI model might find correlations or patterns that wouldn't be readily apparent to the manager, and assist the manager in putting themselves ‘in the shoes’ of a particular employee and figuring out how to empower that employee at work.

In certain yet alternate embodiments of the invented method, an employee may preferably also be able to access the AI model regarding their work, allowing the user to ‘check the scoreboard’ and see how the user is doing and how the user might improve, before hearing about any areas of concern from a manager. The AI model might offer transparency and objectivity in conversations between employee and manager, by giving both parties a same set of independently-gathered data and statistics to refer to in assessing how the employee is performing and how the employee might develop further or earn a promotion.

It is noted that, used well, the invented system and method might preferably provide the benefit of automated management support, increasing the productivity and aiding the good judgment of managers who might otherwise struggle to meet the diverse needs of the employees managed, and thus improve the workplace experience and productivity of everyone involved. At its best, this type of approach may also aid in workplace accessibility, particularly for neurodiverse employees or any other worker who might usually struggle with (and thus be excluded from or disadvantaged in) ‘traditional’ corporate workplace operations, expectations, and practices, such as by providing reminders, cues, and productivity structures custom-built to assist and empower each employee in performing their role. Used properly, this technology could become a tool for countering unconscious workplace bias, providing a data record to inform or examine a manager's more subjective assessment or impression of an employee. This might be particularly critical for discerning more objectively who might be best suited or developed for future leadership positions, when it's been found that even unconscious judgments of who ‘seems like management material’ are a contributing factor to glass-ceiling effects. Such technology even has the potential of functioning as an autonomous, more-objective self-management tool for an independent worker such as a self-employed worker, providing independent feedback on patterns in their working practices that a salaried worker might receive from a good manager and a self-employed worker would be without or have to attempt to provide themselves for themselves, being ‘self-managed’.

However, it should be noted that any technology is only as good as the people who use it, and this is a technology that could also easily be used poorly. For instance, a workplace power imbalance might be made worse by providing management with computer-driven means to conduct one-sided surveillance on employees and calculate their performance and value as workers based on opaque algorithms. Another pitfall here might be for even a well-intentioned manager to start managing just the computer model of an employee, and relying implicitly on what the computer says about a person without actually managing the person and developing an opinion of their own as well. Anyone adopting or utilizing the disclosed invention is encouraged to do so in a way that respects employee dignity; explicitly allows for employees to be human-not-perfect and to know they won't be punished for that; and fosters a culture wherein use of available support structures and proactive development of new workplace skills is viewed as an advancement opportunity, not fixing of or admonishment for a flaw.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

The detailed description of some embodiments of the invention is made below with reference to the accompanying figures, wherein like numerals represent corresponding parts of the figures.

FIG. 1 is a diagram of an electronic communications network, comprising a server, a first user's device, a second user's device, a network-enabled sensor, and an optional application server, all bidirectionally communicatively coupled by means of this network;

FIG. 2 is a block diagram of the first user's device of the electronic communications network of FIG. 1;

FIG. 3 is a block diagram of the second user's device of the electronic communications network of FIG. 1;

FIG. 4 is a block diagram of the server of the electronic communications network of FIG. 1;

FIG. 5 is a block diagram of the optional application server of the electronic communications network of FIG. 1;

FIG. 6 is a process chart presenting a basic invented process of deriving a performance score, selecting a behavioral cue, selecting a cue time, performing the cue, and checking if the cue improved the performance score;

FIG. 7 is a process chart presenting a practical example of the process of FIG. 6 as used to monitor and cue punctuality;

FIG. 8 is a process chart for deriving the performance score of FIG. 6;

FIG. 9 is a process chart presenting in further detail the step of selecting or suggesting a type of cue to use in the process of FIG. 6;

FIG. 10 is a process chart presenting in further detail the step of selecting or suggesting the timing for the cue in the process of FIG. 6;

FIG. 11 is a first diagram presenting an invented human performance model, receiving input regarding employee performance and being utilized to generate predictions and recommendations relevant to the employee's performance;

FIG. 12 is a second diagram presenting an invented human performance model, receiving input regarding employee performance and being utilized to generate predictions and recommendations relevant to the employee's performance;

FIG. 13 is a process chart presenting a process of building and updating the human performance model of FIGS. 11 & 12;

FIG. 14 is a process chart presenting a process of utilizing the human performance model of FIGS. 11 & 12 to assess behavior;

FIG. 15 is a process chart presenting a process of utilizing the human performance model of FIGS. 11 & 12 to select an action, such as a timed cue for the process of FIG. 14;

FIG. 16 is a process chart presenting an example of a decision tree for selecting a cue based on the user's personality, particularly selecting of a cue based on how much noise the cue should make, and how much the cue should disrupt the user's work flow;

FIG. 17 is a diagram presenting stages of training and of application of the human performance model of FIGS. 11 & 12;

FIG. 18 is a diagram presenting stages of acquisition of user data and processing of this data into predictions and suggestions for the user's professional development;

FIG. 19 is a diagram presenting stages of acquisition of user data through a quiz or questionnaire and processing of this data into predictions and suggestions for the user's professional development;

FIG. 20 is a diagram presenting stages of acquisition of user data through linguistic analysis and processing of this data into predictions and suggestions for the user's professional development;

FIG. 21 is a diagram providing further detail regarding the training process of FIG. 17, including example training data;

FIG. 22 is a diagram presenting steps of classifying possible or input data by type or origin, and matching those types of data to recommendations of career paths, predictions of performance, and suggestions for development; and

FIG. 23 is a diagram of the invented system with attention to the connection pattern between various different elements in practicing the invented method.

### DETAILED DESCRIPTION OF DRAWINGS

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the range's limits, an excluding of either or both of those included limits is also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.)

Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Additionally, it should be understood that any transaction or interaction described as occurring between multiple computers is not limited to multiple distinct hardware platforms, and could all be happening on the same computer. It is understood in the art that a single hardware platform may host multiple distinct and separate server functions.

Throughout this specification, like reference numbers signify the same elements throughout the description of the figures.

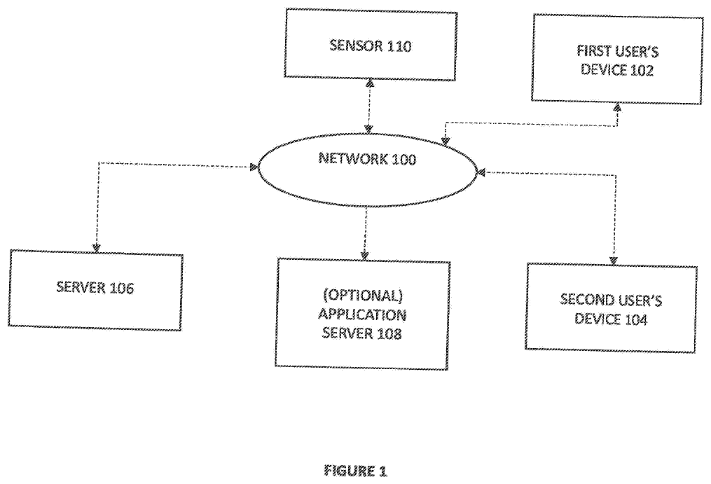

Referring now generally to the Figures, and particularly to FIG. 1, FIG. 1 is a diagram of an electronic communications network 100, comprising a first user's device 102, a second user's device 104, a server 106, an optional application server 108, and a network-connected sensor 110, all bidirectionally communicatively coupled by means of this network 100.

It is understood that the term ‘server’ is being used herein as referring collectively to the hardware and software of a computer that together enable and direct this computer to make available or provide a certain service. In the present instance, the relevant service being provided by the server 106 and/or the application server 108 may include hosting of and access to the invented system and method, via enabling software that may include storage and support of one or more invented human performance models in addition to other enabling software SW. SRC installed on the server 106 and/or the application server 108, including but not limited to standard network utilities as known in the art. It is noted that utilizing of a server to provide access to a service used by multiple users, or to a specialized application that may require its own processing power and memory storage or may otherwise be difficult to just install on every computer that might utilize it, is very much within the typical usage of servers in the art.

Therefore, the server 106 and the application server 108 as presented in FIG. 1 and referenced throughout are understood to each represent both a physical computer connected to a network 100 by physical means such as a cable or wireless mechanism, and also the software hosted by this same computer that enables bidirectional data transmission and reception by means of the electronic communications network 100, in addition to software functions enabling this server's providing the service relevant to the present invention, namely access to software functionality and stored models and data in accordance with the invented method. Additionally, it should be noted that a single computing platform with sufficient capacity to do so may host multiple server functions; therefore, while it might still be helpful conceptually to think of each server function as a separate computer communicating within a network together, one should remember that sometimes the ‘other computer’ being communicated with might in fact be the same computer platform, enacting a different server function. That also means that the present invented method might be occurring all on the same computing platform, or distributed across multiple computing platforms as presented here.

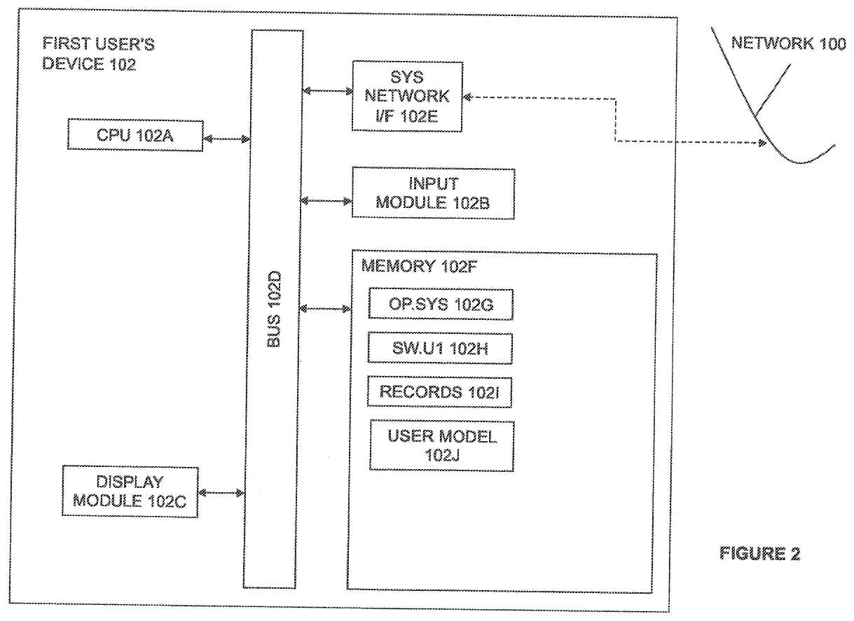

Referring now generally to the Figures, and particularly to FIG. 2, FIG. 2 is a block diagram of the first user's device 102 of the electronic communications network 100 of FIG. 1 and displaying together both hardware and software aspects thereof, wherein the first user's device 102 system comprises: a central processing unit or “CPU” 102A; an input module 102B;

a display module 102C; a software bus 102D bi-directionally communicatively coupled with the CPU 102A, the input module 102B, the display module 102C; the software bus 102D is further bi-directionally coupled with a network interface 102E, enabling communication with alternate computing devices by means of the electronic communications network 100; and a memory 102F. The software bus 102D facilitates communications between the above-mentioned components of the first user's device 102.

The memory 102F of the first user's device 102 includes a server software operating system OP.SYS 102G. The server software OP.SYS 102G of the first user's device 102 may be selected from freely available, open source and/or commercially available operating system software, to include but not limited to a.) a Z8 G4 computer workstation marketed by Hewlett Packard Enterprise of San Jose, Calif. and running a Red Hat Linux™ operating system marketed by Red Hat, Inc. of Raleigh, N.C.; (b.) a Dell Precision™ computer workstation marketed by Dell Corporation of Round Rock, Tex., and running a Windows™ 10 operating system marketed by Microsoft Corporation of Redmond, Wash.; (d.) a Mac Pro workstation running MacOS X™ as marketed by Apple, Inc. of Cupertino, Calif.; or (e.) other suitable computational system or electronic communications device known in the art capable of providing networking and operating system services as known in the art.

The exemplary server software program SW.U1 104H consisting of executable instructions and associated data structures is optionally adapted to enable the second user's device 104 to (a.) process communications with and process messages received from other devices on the network 100, and (b.) provide administrator control and at least partial client access to the processes, methods, results, or benefits of the invented system and method as described herein.

The first user's device 102 might be considered as a work computer or device assigned to a single worker, such as the desktop tower under their work desk, a company-owned laptop or phone, and so on. The first user's device 102 might include input components providing functionality that can be used to monitor the worker, such as a system microphone, software recording keypresses or screen content, work-related applications that report their operation, and so on. Accordingly, the memory 102F may include storage for such gathered data, and may even include storage for or access to the human performance model or aspects thereof pertaining to this particular user, a user model 102J. It is noted that, alternatively or additionally, a plurality of human performance models belonging to several employees might be hosted or archived on a central server, or even on the employee's manager or team leader's work computer instead. The first user's device 102 may also provide a medium for delivering cues or reminders as outlined herein, such as by displaying a visual or text cue on the display interface, playing a sound to provide an aural cue, using haptics to provide a vibration cue, and so on.

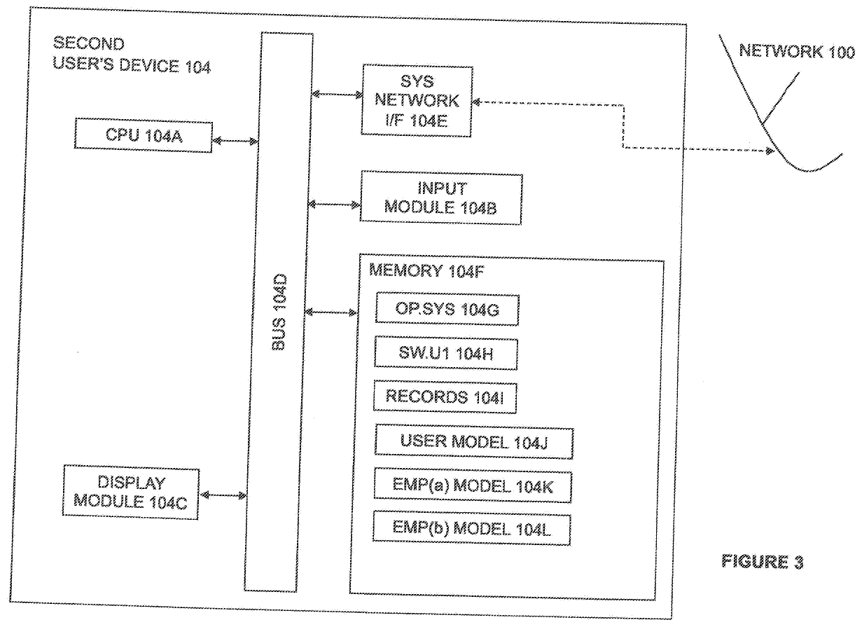

Referring now generally to the Figures, and particularly to FIG. 3, FIG. 3 is a block diagram of the second user's device 104 of the electronic communications network 100 of FIG. 1 and displaying together both hardware and software aspects thereof, wherein the second user's device 104 system comprises: a central processing unit or “CPU” 104A; an input module 104B; a display module 104C; a software bus 104D bi-directionally communicatively coupled with the CPU 104A, the input module 104B, the display module 104C; the software bus 104D is further bi-directionally coupled with a network interface 104E, enabling communication with alternate computing devices by means of the electronic communications network 100; and a memory 104F. The software bus 104D facilitates communications between the above-mentioned components of the second user's device 104.

The memory 104F of the second user's device 104 includes a server software operating system OP.SYS 104G. The server software OP.SYS 104G of the server 106 may be selected from freely available, open source and/or commercially available operating system software, to include but not limited to a.) a Z8 G4 computer workstation marketed by Hewlett Packard Enterprise of San Jose, Calif. and running a Red Hat Linux™ operating system marketed by Red Hat, Inc. of Raleigh, N.C.; (b.) a Dell Precision™ computer workstation marketed by Dell Corporation of Round Rock, Tex., and running a Windows™ 10 operating system marketed by Microsoft Corporation of Redmond, Wash.; (d.) a Mac Pro workstation running MacOS X™ as marketed by Apple, Inc. of Cupertino, Calif.; or (e.) other suitable computational system or electronic communications device known in the art capable of providing networking and operating system services as known in the art.

The exemplary server software program SW.U2 104H consisting of executable instructions and associated data structures is optionally adapted to enable the second user's device 104 to (a.) process communications with and process messages received from other devices on the network 100, and (b.) provide administrator control and at least partial client access to the processes, methods, results, or benefits of the invented system and method as described herein.

The second user's device 104 might be considered as a work computer or device assigned to a single worker, such as the desktop tower under their work desk, a company-owned laptop or phone, and so on. The second user's device 104 might include input components providing functionality that can solely or additionally be used to monitor the worker, such as a system microphone, software recording keypresses or screen content, work-related applications that report their own operation, and so on. Accordingly, the memory 104F may include storage for such gathered data, and may even include storage for or access to the human performance model or aspects thereof pertaining to this particular user, a user model 104J. It is noted that, alternatively or additionally, a plurality of human performance models belonging to several employees might be hosted or archived on a central server, or even on the employee's manager or team leader's work computer instead. The diagram of FIG. 3 presents a manager's computer memory 104F, currently storing a user model 104J pertaining to this manager and those of two of this manager's employees, a first employee model 104K and a second employee model 104L, as a possible example. The second user's device 104 may also provide a medium for delivering cues or reminders as outlined herein, such as by displaying a visual or text cue on the display interface, playing a sound to provide an aural cue, using haptics to provide a vibration cue, and so on.

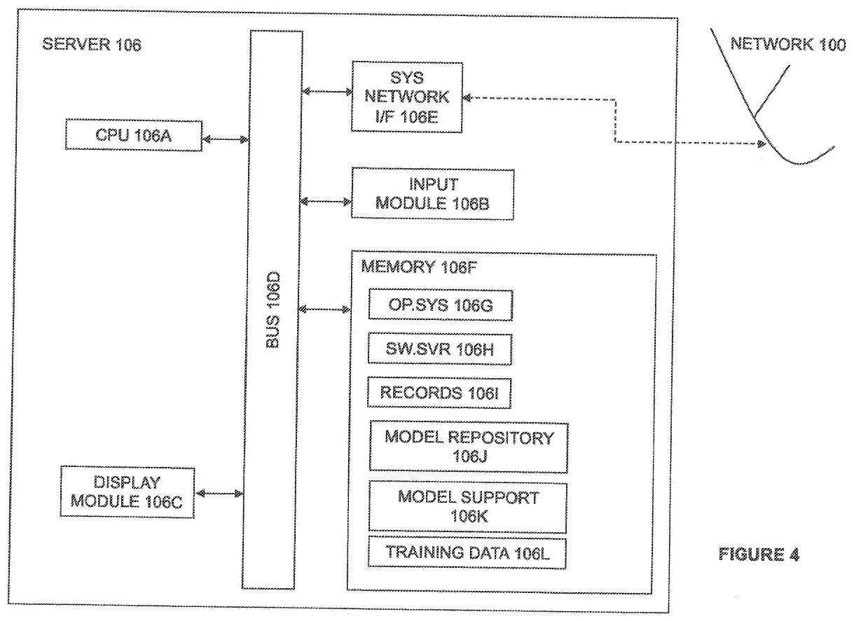

Referring now generally to the Figures, and particularly to FIG. 4, FIG. 4 is a block diagram of the server 106 of the electronic communications network 100 of FIG. 1 and displaying together both hardware and software aspects thereof, wherein the server 106 system comprises: a central processing unit or “CPU” 106A; an input module 106B; a display module 106C; a software bus 106D bi-directionally communicatively coupled with the CPU 106A, the input module 106B, the display module 106C; the software bus 106D is further bi-directionally coupled with a network interface 106E, enabling communication with alternate computing devices by means of the electronic communications network 100; and a memory 106F. The software bus 106D facilitates communications between the above-mentioned components of the server 106.

The memory 106F of the server 106 includes a server software operating system OP.SYS 106G. The server software OP.SYS 106G of the server 106 may be selected from freely available, open source and/or commercially available operating system software, to include but not limited to a.) a Z8 G4 computer workstation marketed by Hewlett Packard Enterprise of San Jose, Calif. and running a Red Hat Linux™ operating system marketed by Red Hat, Inc. of Raleigh, N.C.; (b.) a Dell Precision™ computer workstation marketed by Dell Corporation of Round Rock, Tex., and running a Windows™ 10 operating system marketed by Microsoft Corporation of Redmond, Wash.; (d.) a Mac Pro workstation running MacOS X™ as marketed by Apple, Inc. of Cupertino, Calif.; or (e.) other suitable computational system or electronic communications device known in the art capable of providing networking and operating system services as known in the art.

The exemplary server software program SW.SVR 106H consisting of executable instructions and associated data structures is optionally adapted to enable the server 106 to (a.) process communications with and process messages received from other devices on the network 100, and (b.) provide administrator control and at least partial client access to the processes, methods, results, or benefits of the invented system and method as described herein. The memory 106F of the server 106 may further include or contain one or more stored records 106I or other data, may include or contain data storage such as a model repository 106I containing multiple user models pertaining to different users; for instance, the whole office's user models might be stored centrally on the server, rather than on individual PCs. The memory 106F of the server 106 may further include or contain model support 106K resources, such as data or software supporting usage and development of the models in accordance with the invented system and method, such as training data 106L, software for training human performance models in general, software for comparing or improving human performance models in general, and other such software and data support required to practice the invented system and method besides the models themselves.

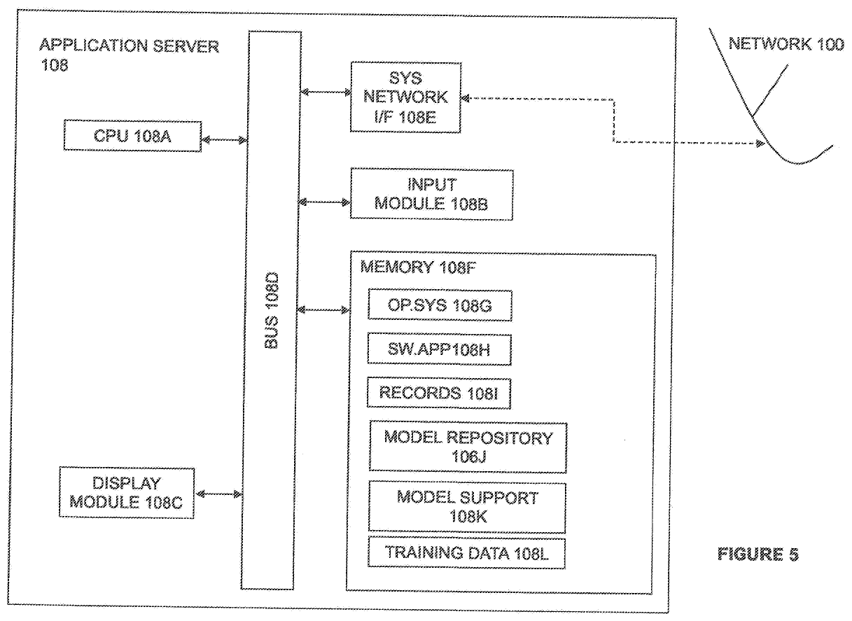

Referring now generally to the Figures, and particularly to FIG. 5, FIG. 5 is a block diagram of the application server 108 of the electronic communications network 100 of FIG. 1 and displaying together both hardware and software aspects thereof, wherein the application server 108 system comprises: a central processing unit or “CPU” 108A; an input module 108B; a display module 108C; a software bus 108D bi-directionally communicatively coupled with the CPU 108A, the input module 108B, the display module 108C; the software bus 108D is further bi-directionally coupled with a network interface 108E, enabling communication with alternate computing devices by means of the electronic communications network 100; and a memory 108F. The software bus 108D facilitates communications between the above-mentioned components of the application server 108.

The memory 108F of the server 108 includes a server software operating system OP.SYS 108G. The server software OP.SYS 108G of the server 108 may be selected from freely available, open source and/or commercially available operating system software, to include but not limited to a.) a Z8 G4 computer workstation marketed by Hewlett Packard Enterprise of San Jose, Calif. and running a Red Hat Linux™ operating system marketed by Red Hat, Inc. of Raleigh, N.C.; (b.) a Dell Precision™ computer workstation marketed by Dell Corporation of Round Rock, Tex., and running a Windows™ 10 operating system marketed by Microsoft Corporation of Redmond, Wash.; (d.) a Mac Pro workstation running MacOS X™ as marketed by Apple, Inc. of Cupertino, Calif.; or (e.) other suitable computational system or electronic communications device known in the art capable of providing networking and operating system services as known in the art.

The exemplary application server software program SW.APP 106H consisting of executable instructions and associated data structures is optionally adapted to enable the server 108 to (a.) process communications with and process messages received from other devices on the network 100, and (b.) provide administrator control and at least partial client access to the processes, methods, results, or benefits of the invented system and method as described herein. The memory 108F of the application server 108 may further include or contain one or more stored records 108I or other data, may include or contain data storage such as a model repository 108J containing multiple user models pertaining to different users; for instance, the whole office's user models might be stored centrally on the server, rather than on individual PCs. The memory 108F of the application server 108 may further include or contain model support 108K resources, such as data or software supporting usage and development of the models in accordance with the invented system and method, such as training data 108L, software for training human performance models in general, software for comparing or improving human performance models in general, and other such software and data support required to practice the invented system and method besides the models themselves.

It is noted that this optional application server is enabled herein in addition to the server 106 to make clear the extent to which the processes, data storage, and other aspects of the invented method and system might be split across a network. For instance, one or more ‘behind the scenes’ servers may handle the ‘heavy lifting’ of consolidating data from various sources and building and updating complex AI models, while another server (or even a few, in a large operation) may provide an ‘access point’ or interface for employees and managers to use when interacting with the invented system on a daily basis.

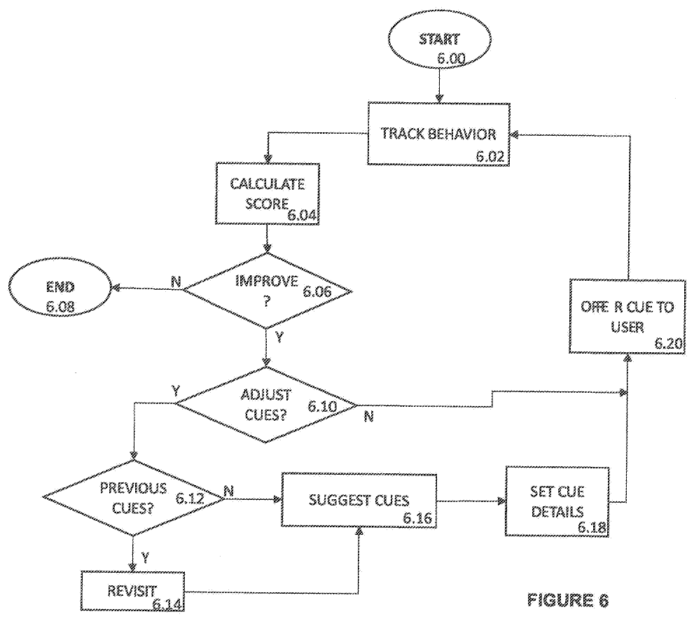

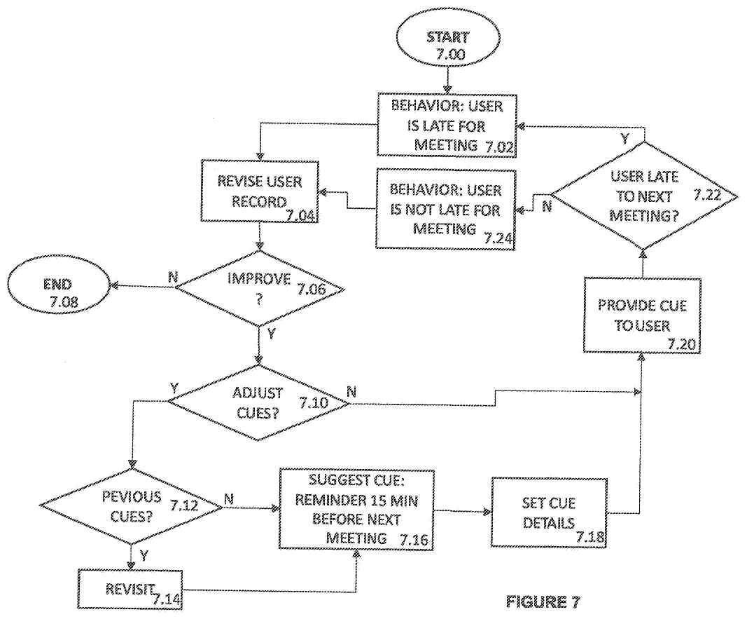

Referring now generally to the Figures, and particularly to FIG. 6, FIG. 6 is a process chart presenting a basic invented process of deriving a performance score, selecting a behavioral cue, selecting a cue time, performing the cue, and checking if the cue improved the performance score. In step 6.00, the process starts. In step 6.02, the behavior of a user such as an employee is tracked and monitored. In step 6.04, a score is calculated based on the user's performance as tracked and monitored in step 6.02. In step 6.06, it is determined whether or not an improvement in this user's performance is sought; this might be by checking the score against a preset threshold, by reporting the score or data and eliciting input from the user or the user's manager, or other manner of determining this. If no improvement is sought, then the process might be over at step 6.08. Otherwise, in step 6.10, it is determined whether to adjust what cues the user is receiving, such as alarms or promptings. Using the simple example of punctuality, which is further presented in FIG. 7, it might have been observed that this user is late to certain meetings; a cue that might help the user get to meetings on time might perhaps consist of a calendar entry or an alarm. If the user is still late to meetings, it might be time to adjust or revisit existing cues, or try something else. On the other hand, this might have been a fluke or an emergency may have arisen that made this a special case; it may not always be indicated to adjust cues. If so, though, at step 6.12 it's determined whether to change previously-set cues, or just add on new ones. A prior cue might be an alarm already set to try to get this user to the meeting on time; if the user is still late, then whatever the current cues might be, these cues aren't effective at getting the user to the meeting on time. If there are previous cues, in step 6.12 it is determined whether to revisit or adjust those existing cues to something else that might be more effective; if so, in step 6.14 the cue(s) are revisited. Regardless of whether previous cues are revisited, additional or further cues might be suggested in step 6.16; for instance, if an alarm set for fifteen minutes before the meeting is a helpful warning but tends to get ‘snoozed’ because the conference room is only five minutes away and that's ten more minutes to wrap up what the user might be working on (the writer is speaking from personal experience here), maybe a second alarm at six minutes until the meeting, when the user actually needs to just put down the mouse and start walking, will actually make the difference there. Suggesting cues predicted to improve the user's performance, based on past performance and user information, is a function of the AI model. It is noted that a cue might be suggested but not implemented; this might be a suggestion made to the user that the user could accept or reject (or even counteroffer), a suggestion made to the user's manager to approve or reject, or a possibility entertained by the AI and either implemented or dismissed. It is noted that offering a user a choice between multiple prompts or cues might make imposition of a new cue more palatable to the user (because it's one the user chose and agreed to), and also be a good way to get a sense of which kinds of cues the user might prefer overall. In step 6.18, the details are set regarding a new cue, such as, as some optional examples, including but not limited to some of the following: what kind of cue, the timing of the cue, what the cue looks like or sounds like, and even data about what the cue was started for and what results would indicate that the cue is or isn't helpful, or is or isn't addressing the intended concern. Having adjusted the cues received by the user or declined to do so, the results will become apparent when next the user is cued and what happens next is observed. For instance, in the punctuality example, the next time there's a meeting. The user is provided in step 6.20 with the currently set cues—whether that's the same cues as last time, a new cue or cues, or none at all. This may include suggesting or offering one or more new cues to the user and eliciting their selection or consent, or simply adjusting the set of cues such that the new cue is included from now on. Then the loop repeats; in step 6.02, the user's behavior is observed: in the punctuality example, that would be whether or not the current batch of cues actually gets the user to the meeting on time this time.

Referring now generally to the Figures, and particularly to FIG. 7, FIG. 7 is a process chart presenting a practical example of the process of FIG. 6 as used to monitor and cue punctuality. In step 7.00, the process starts. In step 7.02, the behavior of a user such as an employee is tracked and monitored—specifically, in this example, that the user is late for a meeting. In step 7.04, the user's record is updated based on the user's performance as tracked and monitored in step 7.02. In step 7.06, it is determined whether or not an improvement in this user's performance is sought; if the user is usually on time and this is considered an outlier, or if there was an emergency or the user wasn't there because the user was out sick or something, the user's being late just this once might not warrant doing anything differently or attempting to ‘improve’ the user's performance. If no improvement is sought, then the process might be over at step 7.08. Otherwise, in step 7.10, it is determined whether to adjust what cues the user is receiving, such as alarms or promptings. If so, though, at step 7.12 it's determined whether to change previously-set cues, or just add on new ones. A prior cue might be an alarm already set to try to get this user to the meeting on time; if the user is still late, then whatever the current cues might be, those cues aren't effective at getting the user to the meeting on time. If there are previous cues, in step 7.12 it is determined whether to revisit or adjust those existing cues to something else that might be more effective; if so, in step 7.14 the cue(s) are revisited. Regardless of whether previous cues are revisited, additional or further cues might be suggested in step 7.16; in this example instance, the suggested cue is a reminder 15 minutes before the start of the meeting. Suggesting cues predicted to improve the user's performance, based on past performance and user information, is a function of the AI model. It is noted that a cue might be suggested but not implemented; this might be a suggestion made to the user that the user could accept or reject (or even counteroffer), a suggestion made to the user's manager to approve or reject, or a possibility entertained by the AI and either implemented or dismissed. It is noted that offering a user a choice between multiple prompts or cues might make imposition of a new cue more palatable to the user (because it's one the user chose), and may also be a good way to get data regarding which kinds of cues the user might prefer overall, and whether those kinds of cues actually work for that user when that user receives them. In step 7.18, the details are set regarding a new cue, such as, as some optional examples, including but not limited to some of the following: what kind of cue, the timing of the cue, what the cue looks like or sounds like, and even data about what the cue was started for and what results would indicate that the cue is or isn't helpful, or is or isn't addressing the intended concern. Having adjusted the cues received by the user or declined to do so, the results will become apparent when next the user is cued and what happens next is observed. For instance, in the punctuality example, the next time there's a meeting. The user is provided in step 7.20 with the currently set cues—whether that's the same cues as last time, a new cue or cues, or none at all. At step 7.22, it is determined whether the cue helped: in this case, whether the user is on time to the meeting. If so, then in step 7.24 the user gets to the meeting on time.

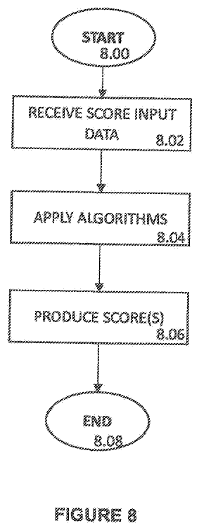

Referring now generally to the Figures, and particularly to FIG. 8, FIG. 8 is a process chart for deriving the performance score of FIG. 6. This chart might be considered as ‘nested inside’ step 6.04 of FIG. 6, providing further detail for accomplishing that step. At step 8.00, the process starts. At step 8.02, input data is received regarding the user's performance or score, such as observed behavior, meeting attendance, or other data input as explicated throughout the disclosure. In step 8.04, algorithms are applied to the raw data. This may be anything required or preferred for processing the input data into something that might signify in producing the user's score, such as speech-to-text, language processing, comparing recent meeting attendance to previous meeting attendance, and so on. In step 8.06, one or more user scores are produced. It is noted that there could be one overall score for each employee, a set of scores in different categories for each employee, a group score for multiple employees working together, or any other scores that might be considered suitable and useful here. The process ends at step 8.08.

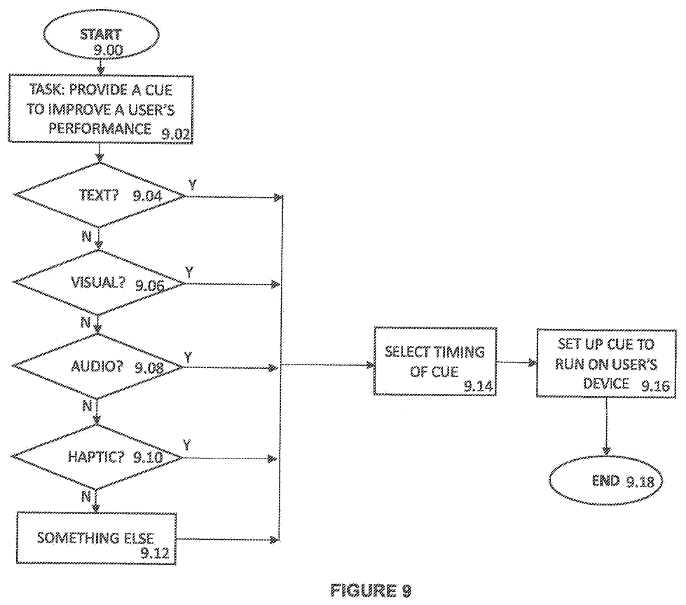

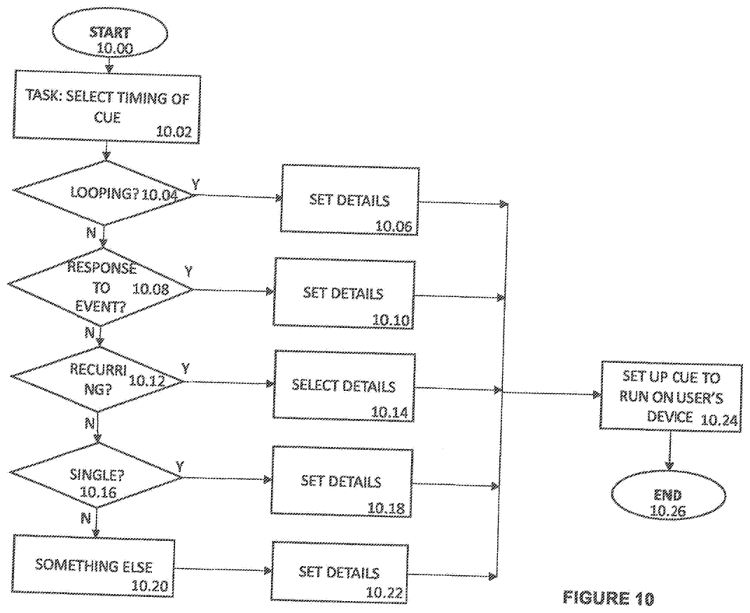

Referring now generally to the Figures, and particularly to FIG. 9, FIG. 9 is a process chart presenting in further detail the step of selecting or suggesting a type of cue to use in the process of FIG. 6. The process starts at step 9.00. In step 9.02, the task of providing a cue predicted to improve a user's performance is established. It is understood that predicting what kind of cue would effectively support some selected specific worker in adopting a new work practice or improving a work skill a function of the computer AI model of the user's behavior, performance, personality, ability, and so on as explicated herein, and what cues are selected or suggested may be based on the user's personality, which cues have worked well for this user previously, which cues have worked well for other users previously in trying to build this same skill or adopt this same practice, what kinds of cues or reminders the user has requested before or set up for themselves, or any other data or analysis that might be found relevant here. In step 9.04, a text reminder is considered as an option; this may be some text appearing on the user's computer screen, a text message sent to the user's phone, a ‘cheat sheet’ for the user to print out and have at their desk, or anything else in the medium of text-based reminders. If a text-based reminder is not indicated, in step 9.06 a visual reminder is considered next; this may be a desktop background, a reminder in the form of a funny picture, a pop-up window, or something similar in a visual medium, such as displayed on the user's computer screen. It is noted that ‘hybrid’ reminders—such as visuals which also include text—are possible and indeed may be difficult to avoid in many cases; this chart isn't intended to draw sharp distinctions between these, but rather to enumerate certain key media of note that are among those that might be considered as media for delivering cues in. If a visual medium is not indicated, in step 9.08 an audio reminder is considered, such as an alarm, turning music on/off or changing the song, a sound effect, or something similar. If an audio reminder is not indicated, in step 9.10 a haptic reminder is considered, such as receiving a ‘buzz’ instead of a loud alarm noise. If a haptic reminder is not indicated, then other media of cues might be considered; any and all of these are collectively represented by step 9.12, and it is again noted that this chart isn't intended to represent an exhaustive list of possible cue media or variety of cues. It is further noted that different cues work better for different people in different situations, and a wide variety of cues and options may provide improved support and accessibility for all, and may be more likely to result in users changing their behavior in positive ways. Once a medium of cue has been selected, in step 9.14, such as text, visual, audio, or haptic, the timing of the cue is selected next, such as ‘next Tuesday at noon’, ‘fifteen minutes before every meeting’, or ‘every half hour’. This selection is further explicated in FIG. 10, which may be viewed as nested inside step 9.14. Once the medium and timing of the cue has been selected, one or more devices associated with the user, such as their work computer or phone, is set up to run the cue as selected. It is noted that most modern smartphones have their own mechanisms for setting alarms and calendar reminders, and that similar utilities also exist on most laptop or desktop computers; something like this might also be set up as a cron task or shell script, depending on the computing environment, and modern computing environments already generally include the means for supporting a wide variety of media for providing possible cues. It is noted that the matter of FIG. 9 might be interpreted as correlated to steps 6.16, 6.18, and 6.20 of FIG. 6, that is selecting a cue and providing the selected cue to the user. It is noted that a selected cue may also be approved by the user or their manager before being implemented, and that the user or their manager may also be notified as to what cue and when has been implemented.

Referring now generally to the Figures, and particularly to FIG. 10, FIG. 10 is a process chart presenting in further detail the step of selecting or suggesting the timing for the cue in the process of FIG. 6 and FIG. 9. In step 10.00, the process begins. In step 10.02, the task is established of selecting a timing for a cue to occur at, such as such as ‘next Tuesday at noon’, ‘fifteen minutes before every meeting’, or ‘every half hour’. In step 10.04, a ‘looping’ option is considered. The “looping” option may be for providing reminders to perform certain practices regularly throughout the workday, such as reporting progress regularly on an ongoing project, checking in on a project one is managing, standing up and stretching, looking away from the computer screen for one's eye health, or drinking water. Therefore, this kind of cue timing might be set to a certain repeating interval at step 10.06, such as ‘every twenty minutes’ or ‘every other day’, rather than set to occur at a specific time of day. Alternatively, the cue timing might be a response to an event, such as ‘anytime you complete a project (make sure to hit spellcheck before turning it in)’ or ‘anytime a meeting is scheduled (have an alarm set to get there on time)’. This kind of conditional cue might be set to occur right when the condition event happens—such as a pop-up reminding one to spell-check a project that was just marked complete—or might be set up in response to a calendar event, such as the scheduling of a meeting triggering the scheduling of an alarm fifteen minutes prior. In step 10.10, those kinds of details are set up for a ‘response’ timing. Otherwise, in step 10.12, it is determined whether this might be a cue that should be timed as a recurring scheduled event, such as an alarm every Thursday at noon (for example) to go pick up the office's mail. If so, in step 10.18, details like (for example) ‘Thursday at noon’ are specified. Otherwise, step 10.16 determines whether this might be a one-time cue; maybe there's a special event coming up requiring some extra cueing, or maybe what's indicated is to try setting alarm just for the next meeting rather than every meeting from now on. If so, in step 10.18 the details are set for the one-time cue, such as the time and date. This, again, is not an exhaustive list of possible timings, and other possibilities are collectively represented by step 10.20, wherein something else besides the listed options is specified. In step 10.22, details are specified for that option, whatever the details may be that are relevant to that option. Once the cue timing is established, the cue is set up to run on the user's device, as mentioned regarding FIG. 9. It is noted that a cue generally needs both a medium and timing (i.e. a what happens and a when it happens) in order to actually be implemented; otherwise, there is recorded either a selected time at which nothing happens, or a selected something that potentially should happen but no indicated time at which that something should occur.

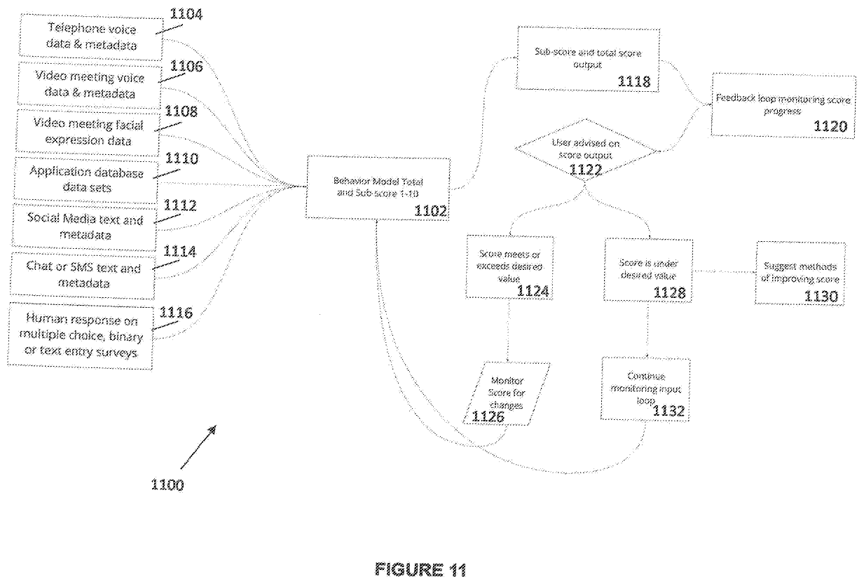

Referring now generally to the Figures, and particularly to FIG. 11, FIG. 11 is a first diagram presenting aspects of an invented human performance model 1100 (“the AI model 1100”), receiving input regarding employee performance and being utilized to generate predictions and perform operations relevant to the employee's performance. More specifically, a Behavior Model Total and Sub-score 1-10 1102 is generated by receiving and processing a plurality of input data items, including but not limited to a dataset of Telephone voice data & metadata 1104; a dataset of Video meeting voice data & metadata 1106; a dataset of Video meeting facial expression data 1108; a dataset of Application database data sets 1110; a dataset of Social Media text and metadata 1112; a dataset of Chat or SMS text and metadata 1114; and a dataset of Human response on multiple choice, binary, or text entry surveys 1116. From these, a Sub-score and total score output 1118 may be generated. Further, a Feedback loop monitoring score progress 1120 may be initiated and maintained to continuously update the calculated score with receipt of new data. All of this supports an ability to advise the user on the score output 1122. In a first case 1124 where the user's score exceeds a desired value, a first action 1126 of continuing to monitor the score for changes may be taken. In a second case 1128 where the user's score is under a desired value, a second action 1130 may be enacted of suggesting methods of improving the user's score, and/or a third action 1132 may be taken of continuing to monitor the input loop.

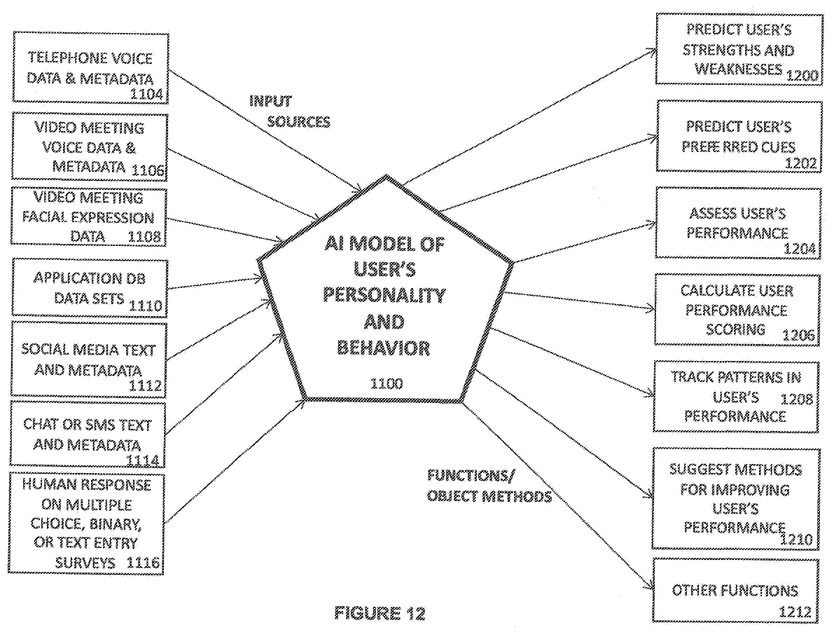

Referring now generally to the Figures, and particularly to FIG. 12, FIG. 12 is a second diagram presenting an invented human performance model, receiving input regarding employee performance and being utilized to generate predictions and recommendations relevant to the employee's performance. The software-based AI model 1100 receives and analyzes a plurality of input data items, including but not limited to the dataset of telephone voice data & metadata 1104; the dataset of video meeting voice data & metadata 1106; the dataset of video meeting facial expression data 1108; the dataset of application database data sets 1110; the dataset of social media text and metadata 1112; the dataset of chat or SMS text and metadata 1114; and the dataset of human response on multiple choice, binary, or text entry surveys 1116. Based on all of this raw data, analysis thereof, and inferences therefrom, the AI model 1100 provides and performs several object methods, functions, and/or services, based on its ‘understanding’ of who this user is as an employee. Some of these functions may include: a first prediction function 1200 which may predict the user's likely strengths and weaknesses; a second prediction function 1202 which may predict how best to prompt the user (which may be useful in the processes of FIGS. 6 through 10); an assessment function 1204 which may assess a user's performance; a score-generating function 1206 which may produce a rating or score for the user's assessed performance; a pattern tracking function 1208 which may analyze the user performance data to discern patterns, such as trends or repeated habits; a suggestion function 1210 which may suggest methods or options for improving the user's current performance; and other functions 1212 not listed here, as this list is not intended to be exhaustive. A few other functions might include, for example, predicting a user's optimal career track, suggesting which technical or developmental training options the user might find most useful.

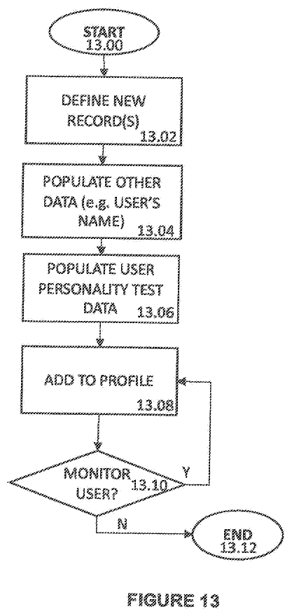

Referring now generally to the Figures, and particularly to FIG. 13, FIG. 13 is a process chart presenting a process of building and updating the human performance model of FIGS. 11 & 12. In step 13.00, the process starts. In step 13.02, one or more new record(s) are defined. In step 13.04, the record(s) created in step 13.02 may be populated, such as via data entry, with basic record information such as the name of the person to whom the record pertains. In step 13.06, the record(s) may be further populated with data from aptitude or personality tests taken by the user. In step 13.10, the user may be ongoingly monitored to provide more record data. If the monitoring ceases, the process ends at step 13.12.

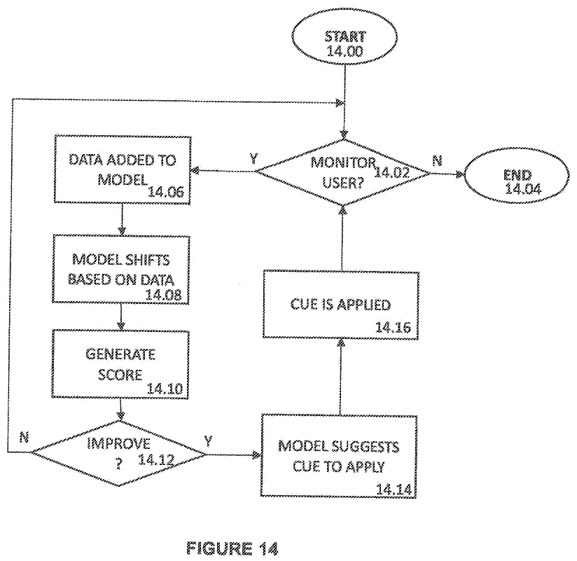

Referring now generally to the Figures, and particularly to FIG. 14, FIG. 14 is a process chart presenting a process of utilizing the human performance model of FIGS. 11 & 12 to assess behavior. At step 14.00, the process starts. At step 14.02, it is determined whether or not to monitor the user to generate input data. If not, the process ends at step 14.04. If so, the data gathered by monitoring the user is added to the AI model 1100 at step 14.06. At step 14.08, the AI model 1100 reassesses or adjusts based on having received new information. At step 14.10, a score is generated by the AI model 1100. At step 14.12, it is determined whether to seek to improve the generated score. If so, at step 14.14 the AI model 1100 suggests a cue that might impact the user's performance, such as a timed reminder to support punctuality to meetings. At step 14.16, the cue is applied. It is noted that this is a broad overview, and further steps such as considering a selection of cues might also be included here, similar to the processes of FIGS. 6 through 10.

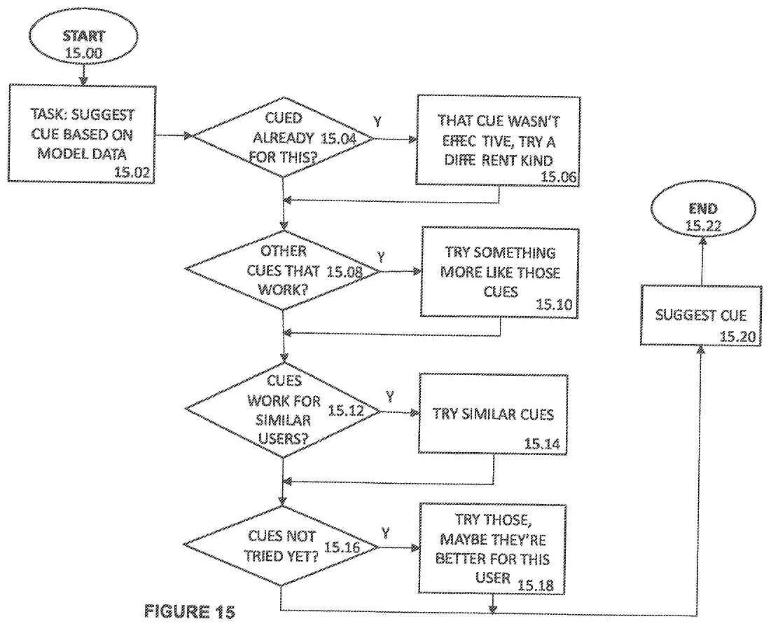

Referring now generally to the Figures, and particularly to FIG. 15, FIG. 15 is a process chart presenting a process of utilizing the human performance model of FIGS. 11 & 12 to select or suggest an action, such as a timed cue for the process of FIG. 14. At step 15.00, the process starts. At step 15.02, the task is established of suggesting a cue based on the AI model 1100. In step 15.04, it is checked whether a cue has been tried already. For instance, if the task is to set a cue to get a user to a meeting on time, and the user is still late even though there's already an alarm cue for their meetings, then it might be inferred at step 15.06 that the existing alarm cue didn't work for the user and it may be time to try something else. At step 15.08, it is determined whether there are other cues being currently provided for the user that have been demonstrated to be effective, such that this might offer a hint at step 15.10 as to what would work well for a new cue or better than a previous cue demonstrated to be ineffective. At step 15.12, it is determined whether there is a kind of cue that seems to have worked well for similar users and/or in a similar situation, as a more preferred cue to try next; maybe what worked for another user might work well for this user too, for whatever reason, and AI models 1100 for different users might be able to learn from each other or share effective solutions. If so, then in step 15.14 those cues might be rated as more preferred, or tried next. It is noted that use of AI technology such as the AI model 1100 allows for a more nuanced consideration of multiple options, and even predictions of relative efficacy based on factors such as the user's personality, the user's responses to previous cues, or any cues that the user has set up for themselves. In step 15.16, it is further considered whether there are varieties of cues that haven't been tried yet; if the current medium or kind of cue isn't working, why not try a totally different one until something sticks. In step 15.18, a different type of cue from those previously tried is considered. In step 15.20, a preferred cue is suggested, and at step 15.22 the process ends.

It is noted that, particularly in a complicated software or AI environment, this process may not be as linear as this chart would indicate; steps may be repeated, or single options might fulfill multiple criteria. This chart is intended to outline what kinds of factors might be considered as part of this process of determining a good recommendation of a cue to offer. It is noted that the cue might be implemented automatically without checking with a human user, or might be offered to the user and/or their manager as a suggested step for development. For instance, a window might pop up on the user's screen saying something like, “You were late to that meeting you just went to, would you like to set up an alarm to warn you five minutes before meetings from now on?” And the user might accept, decline, or counteroffer (e.g. “make that three minutes and lock my computer screen too, that will make me actually put down the mouse and get moving”). The user's response, including repeatedly dismissing offers of cues without trying any of them, might be noted as further data; being chronically late and not trying to do anything about that or accepting any offers of help may be an item for a performance review. But the system might also be able to check in with the worker independently, far ahead of a manager's getting directly involved, and ask the user about why the cues it's offering don't seem to work for the user and what might work better.

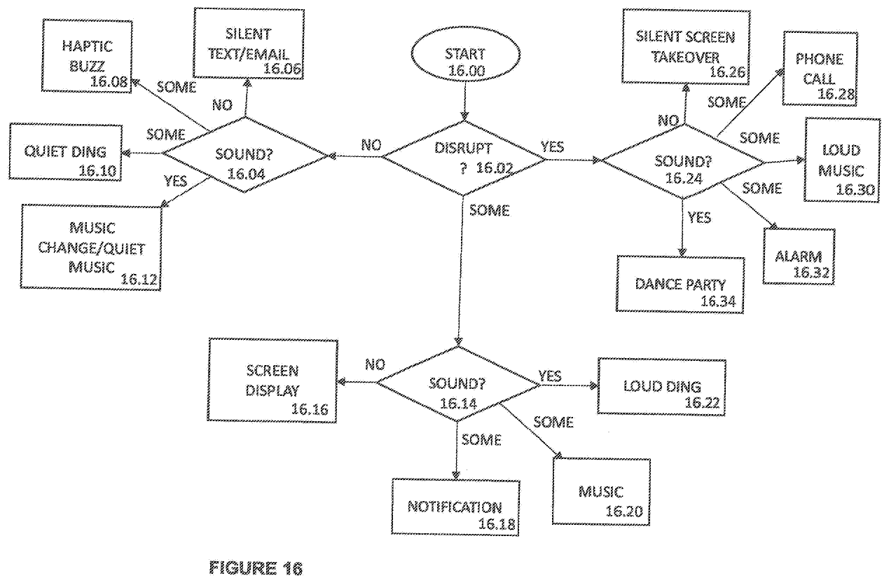

Referring now generally to the Figures, and particularly to FIG. 16, FIG. 16 is a process chart presenting an example of a decision tree for selecting a cue based on the user's personality, particularly selecting of a cue based on how much noise the cue should make, and how much the cue should disrupt the user's work flow. The decision tree starts at node 16.00. At node 16.02, it is determined how disruptive the cue should be, on a scale from ‘I barely noticed it’ to ‘okay, noted’ to ‘I can't keep working, it's too obnoxious’. It is noted that not all prompting need be disruptive, or even should be. The distinction here of ‘disruptive vs. non-disruptive’ is the extent to which it interrupts what the user might be doing. If the user has to drop what they're doing and go to a meeting right away, a disruptive cue is perfect for that; if the user just wants to be occasionally reminded to drink water while working at their desk, repeatedly disrupting their work and wrecking their focus just to tell the user that is likely to be, not just counterproductive to their work, but, speaking from experience, surprisingly obnoxious. A gentler nudge might be called for there. If the cue should not be at all disruptive, then it is next determined at node 16.04 whether this non-disruptive or minimally disruptive cue should have any sound. An example of a non-disruptive, non-sound cue that is nevertheless a useful reminder might be an email or text with no notification 16.06; the user will see the reminder when next the user checks their texts or emails. This might be useful for something like a reminder about a meeting happening the next day, a non-urgent reminder to complete something soon (like selecting benefits or filling out a form for HR), or something similarly non-urgent but requiring an unobtrusive reminder or prompt. Options for providing a non-disruptive reminder with some sound might include a haptic buzz 16.08 or a brief quiet sound effect ('ding!') 16.10; this might be preferred for something like a prompt to drink water, providing a gentle reminder without breaking the user's workflow. An option for a non-disruptive cue with more sound might be turning on some ambient music 16.12, or changing someone's work music already playing to a certain track, as a gentle but persistent reminder of a task to be done. In the case that the cue is preferred to be somewhat disruptive but not very, it is determined at node 16.14 whether the somewhat-disruptive cue should have sound and how much. It is noted that this decision tree only addresses the factors of disruptiveness and noisiness, and many other factors or limitations could be considered with regard to selecting a cue based on its qualities, such as selecting a cue that certain users might find amusing or motivating, selecting a cue with the limitation that it's reasonably courteous to other co-workers having desks nearby, selection of a cue based on whether it's only needed at the user's desk or needs to be able to reach the user while they're walking around the office; and so on. It is noted that each of these would add another layer to this decision tree, which was therefore kept simple to provide basic explanation of this overall concept. It is further noted that other factors like the user's preference or other factors as presented in FIG. 15 and elsewhere herein might weigh into which of these cues is offered or selected. A semi-disruptive, no-sound option might be a screen display 16.16, such as a pop-up window or an icon flashing in the corner of the screen. A few examples of semi-disruptive, some-sound cue options might include a standard notification 16.18, which usually consists of a pop-up box and a little sound effect, or turning on some more noticeable and less ambient music 18.20. A semi-disruptive and noisy cue might be a loud ding or other sound effect 16.22: auditory and significantly noticeable, but brief and not necessarily focus-ruining. If the preferred cue is disruptive—i.e., the user's workflow is to be interrupted and the user should stop whatever they're doing to respond to this cue right away—then at node 16.24, it is determined whether the disruptive cue should include sound and how much. An example of a disruptive cue with no sound might be a screen takeover 16.26; this has no sound, but effectively interrupts whatever one is working on by changing their computer screen display to something else while the cue lasts. This might be an effective cue for getting someone out the door and to a meeting on time who doesn't respond well to auditory cues for whatever reason. Some examples of disruptive cues including some sound might include receipt of a phone call 16.28 (in the manner of a wake-up call from a hotel reception desk), turning on some loud or boisterous music 16.30 (or turning up whatever's already playing), or having a regular alarm 16.32 go off. As an example of ‘noisiest and most disruptive’, there could be an office dance party 16.34—everyone's screens lock for five minutes, party music starts playing, everyone stretches their legs together, and then it's over and everyone goes back to work (or all start trooping toward the same meeting together).

It is noted again that diversity of workers and tasks motivates providing diversity of available cues, and the more different and nuanced options are available, the better the system's ability to support workers' individual needs, meaningfully and positively impact their habits, and provide better workplace accessibility. The AI model 1100 for a deaf worker, for instance, would automatically discount offering audio-only alarms to that person, while a manager communicating to a project team ‘okay, everybody, take a moment and set an alarm for five minutes before the meeting’ as a one-size-fits-all approach might fail to consider each individual being spoken to. An audio-sensitive neurodiverse user might find a loud beeping alarm stressful, and their AI model 1100 might be aware enough of that consideration to offer the user a haptic buzz or a pop-up window on their screen; same reminder, less unnecessary pain, and the user doesn't even have to deal with someone else insensitively saying ‘well why don't you just set a loud alarm like I would, what's your problem?’. And further, a computer utility doesn't generally get ‘impatient’ about requests for extra assistance or with providing accommodation for specific needs or concerns; each user might work with the computer, including through trial and error over time, to set and adjust the cues to best support that user and their work, regardless of whether this user's system of cues is similar to what works for other people.

It is noted that an easy pitfall would be to judge a worker's performance by how many reminders or cues the user might need, as though these were crutches or as though someone who was habitually punctual or who had developed that skill would not need any external assistance or nagging to get to meetings on time. One generally accomplishes a skill like punctuality, not by somehow learning to ‘be perfect’ unaided, but by learning how to use available tools effectively and cue oneself as needed. The best worker is not necessarily the one needing the fewest cues, just as the most punctual person is not necessarily the one who has their calendar memorized and doesn't need to use a planner or calendar app; the tools are there to be used, and a good worker is someone who uses the available tools effectively to support their doing good work. It is noted that the AI model 1100 might even be programmed to take note of a worker who requests to be cued for something that person knows might be difficult for them unaided, or who requests to modify a cue that the person anticipates isn't going to work for them, rather than just letting the computer recommend something once the person fails; that's actually an excellent work practice and a good use of the tools, that someone just counting cues and making assumptions might view as the worker's admitting to being deficient or something. If recommendations or cues made by the invented system can inspire and educate a user to develop their own cues and to insist on having good cues and structures set up to aid their work in the future, even in absence of the invented system, that itself might constitute improvement of an important workplace skill.

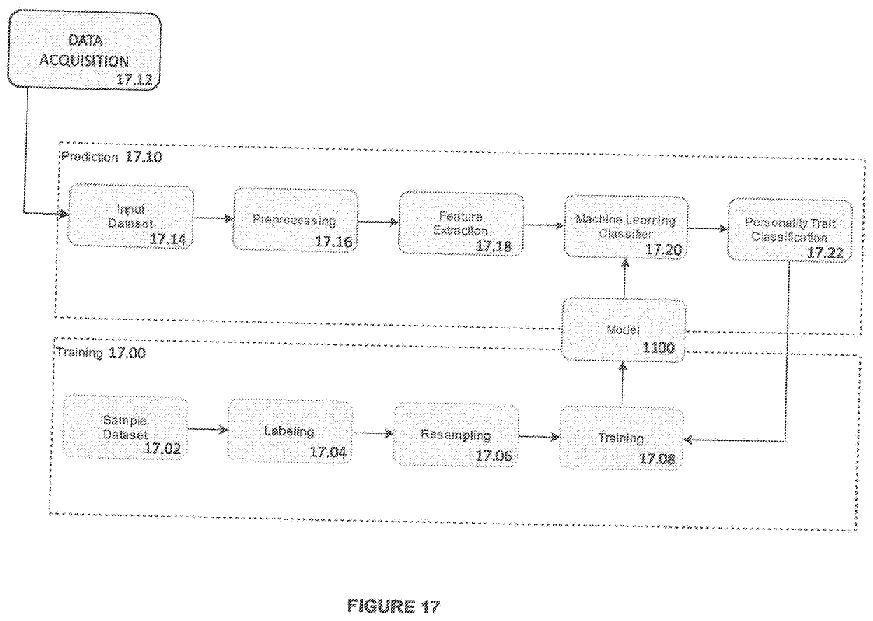

Referring now generally to the Figures, and particularly to FIG. 17, FIG. 17 is a diagram presenting stages of training and of application of the human performance model 1100 of FIGS. 11 & 12. In a training context 17.00, a sample dataset 17.02 undergoes a process of labeling 17.04 (such as by a human administrator providing example judgments for the computer to emulate), the sample dataset undergoes a process of resampling 17.06, and the assembled training data is utilized in training 17.08 of the invented AI model 1100. In a prediction context 17.10 (such as a real-life application of the model), data is acquired 17.12 (such as by monitoring or quizzing a worker) to produce an input dataset 17.14, the input dataset is preprocessed 17.16, features of interest are extracted 17.18 for the consideration of the AI model 1100, these features are considered by a machine learning classifier 17.20 based on the AI model 1100, and the processing informs a personality trait classification 17.22. The inputs and results of this process are also added into the training data 17.08, to improve future processing and training of other similar AI models 1100. Further detail regarding the Prediction process 17.10 is explicated in

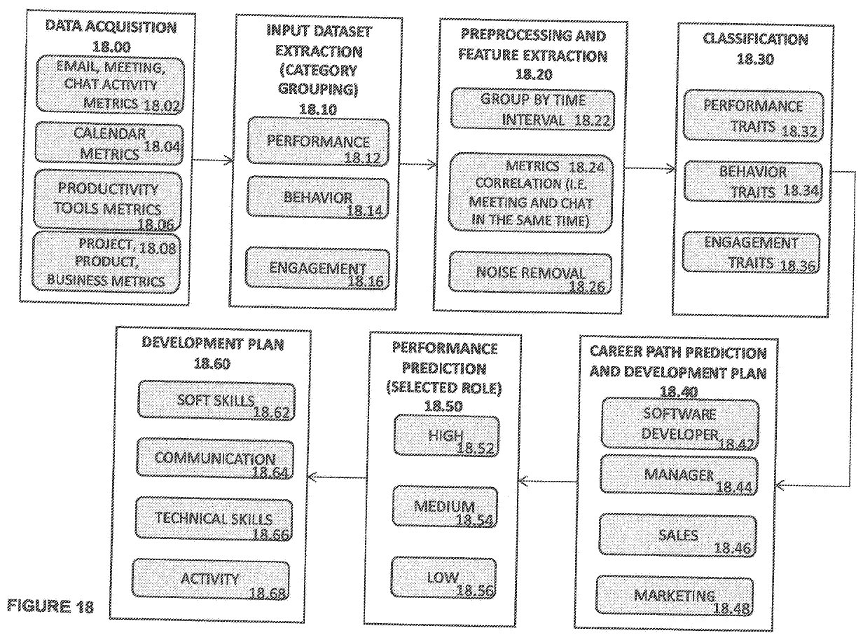

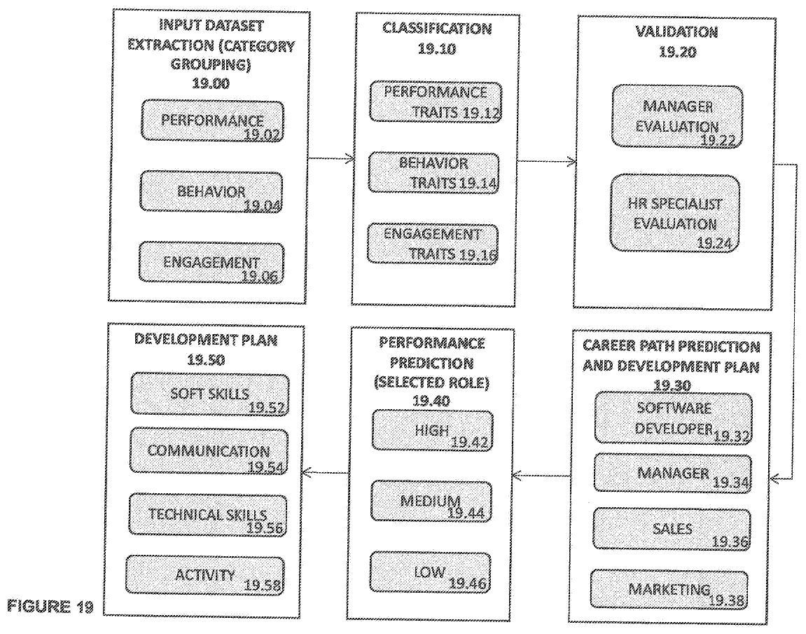

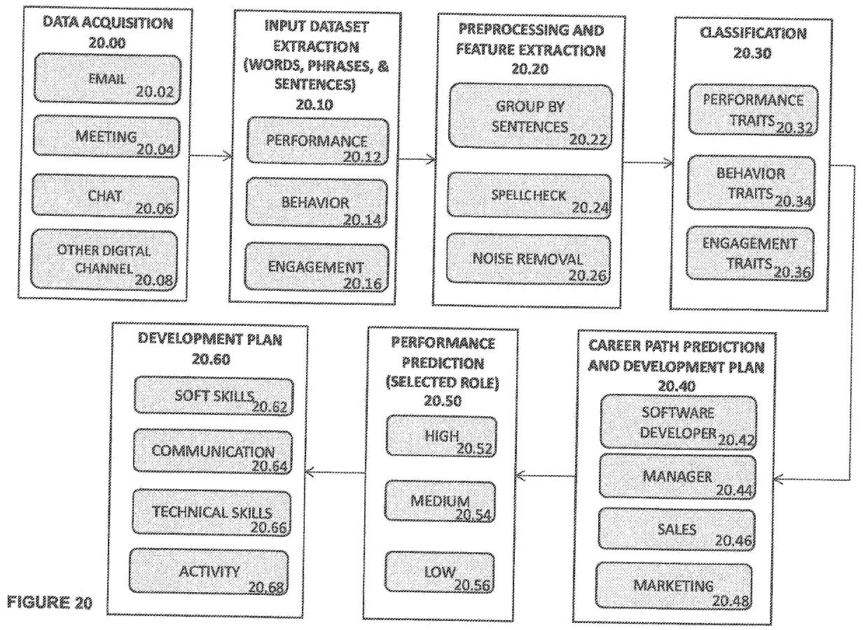

FIGS. 18 and 19; further detail regarding the Training process is explicated in FIG. 20.

Referring now generally to the Figures, and particularly to FIG. 18, FIG. 18 is a diagram presenting stages of acquisition of user data and processing of this data into predictions and suggestions for the user's professional development.

In a data acquisition stage 18.00, user data is acquired. Means for acquiring user data might include monitoring and measuring of participation metrics 18.02 such as participation in meetings, office chat environments, and emails; calendar metrics 18.04, i.e. usage of their calendar; productivity tool metrics 18.06, i.e. usage of other productivity tools; and business results 18.08 produced by the user such as projects completed or products made or sold. In an input dataset extraction stage 18.10, information is extracted from the raw data previously gathered, pertaining to such factors as performance 18.12, behavior 18.14, and engagement 18.16. In a preprocessing and feature extraction stage 18.20, the data is pre-processed, including grouping by time interval 18.22, correlation of metrics 18.24, and removal of extraneous material such as background noise in audio data 18.26. In a classification stage 18.30, the gathered data may be classified by what is being indicated about the user; some data may indicate certain performance traits 18.32, other data may indicate certain behavioral traits 18.34, and still other data may indicate engagement traits 18.36.

In a career path prediction and development plan 18.40, a preferable career path may be suggested or determined, based on the data and its indications regarding this user's strengths and weaknesses as a worker. Some examples of possible career paths that might be recommended here include a software developer career path 18.42, a manager career path 18.44, a sales career path 18.46, and a marketing career path 18.48. A performance level prediction 18.50 may be predicted regarding the user's anticipated performance in the role selected in the career path prediction and development plan 18.40 stage, such as a prediction of high performance 18.52, a prediction of medium performance 18.54, or a prediction of low performance 18.56. A development plan 18.60 may be suggested or implemented regarding developing this user to perform well in a current role, an anticipated future role, or both, such as recommending a program for developing the user's soft skills 18.62 such as interpersonal skills, dependability, and teamwork; a program for developing the user's communication skills 18.64; a program for developing the user's technical skills 18.66; or a program for coaching the user in improving their measured results 18.68, such as suggesting that the user might participate more in office chats and emails to improve their performance metric.

Referring now generally to the Figures, and particularly to FIG. 19, FIG. 19 is a diagram presenting stages of acquisition of user data through a quiz or questionnaire and processing of this data into predictions and suggestions for the user's professional development. It is noted that, because the questionnaire queries the user in a pre-structured manner, less processing of this data is generally required, unlike the raw data obtained by monitoring of FIG. 18, wherein ‘background chatter’ in raw data gets filtered out. In an input dataset extraction stage 19.00, information may be extracted from the questionnaire results data, pertaining to such factors as performance 19.02, behavior 19.04, and engagement 19.06. In a classification stage 19.10, the gathered data may be classified by what is being indicated about the user; some data may indicate certain performance traits 19.12, other data may indicate certain behavioral traits 19.14, and still other data may indicate engagement traits 19.16. In a validation stage 19.20, the results may be validated by an administrator, such as in a manager evaluation 19.22 or an HR specialist evaluation 19.24. In a career path prediction and determination stage 19.30, a preferable career path may be suggested or determined, based on the data and its indications regarding this user's strengths and weaknesses as a worker. Some examples of career paths that might be recommended may include software developer 19.32, manager, 19.34, sales 19.36, and marketing 19.38. In a performance prediction stage 19.40, a performance level may be predicted regarding the user's anticipated performance in the role selected at the fourth stage, such as a prediction of high performance 19.42, a prediction of medium performance 19.44, or a prediction of low performance 19.46. In a development plan stage 19.50, a development plan may be suggested or implemented regarding developing this user to perform well in a current role, an anticipated future role, or both, such as but not limited to recommending a program for developing the user's soft skills 19.52 such as but not limited to interpersonal skills, dependability, and teamwork; a program for developing the user's communication skills 19.54; a program for developing the user's technical skills 19.56; or a program for coaching the user in improving their measured results 19.58, such as suggesting that the user might participate more in office chats and emails to improve their performance metric.

Referring now generally to the Figures, and particularly to FIG. 20, FIG. 20 is a diagram presenting stages of acquisition of user data through linguistic analysis and processing of this data into predictions and suggestions for the user's professional development. Linguistic analysis might generally be performed on a user's emails, texts, chat messages, or other digitally-trackable communications, to get an idea of this person's personality and communication skills. In a data acquisition stage 20.00, user data is acquired. Means for acquiring user data for linguistic analysis might include monitoring and analysis of material such as emails 20.02, meetings 20.04, chat messages 20.06, or other digitally-trackable communications 20.08. In an input dataset extraction stage 20.10, information is extracted from the raw data previously gathered, pertaining to such factors as performance 20.12, behavior 20.14, and engagement 20.16. In a preprocessing and feature extraction stage 20.20, the data is pre-processed, including grouping by sentences 20.22, spellchecking 20.24, and removal of extraneous material 20.26 such as background noise in audio data. In a classification stage 20.30, the gathered data may be classified by what is being indicated about the user; some data may indicate certain performance traits 20.32, other data may indicate certain behavioral traits 20.34, and still other data may indicate engagement traits 20.36. In a career path prediction and development plan stage 20.40, a preferable career path may be suggested or determined, based on the data and its indications regarding this user's strengths and weaknesses as a worker. Some examples of career paths that might be recommended may include software developer 19.32, manager, 19.34, sales 19.36, and marketing 19.38. In a performance prediction stage 20.50, a performance level may be predicted regarding the user's anticipated performance in the role selected at the previous stage, such as high performance 20.52, medium performance 20.54, or low performance 20.56. In a development plan stage 20.60, a development plan may be suggested or implemented regarding developing this user to perform well in a current role, an anticipated future role, or both, such as recommending a program for developing the user's soft skills 20.62 such as interpersonal skills, dependability, and teamwork; a program for developing the user's communication skills 20.64; a program for developing the user's technical skills 20.66; or a program for coaching the user in improving their measured results 20.68, such as suggesting that the user might participate more in office chats and emails to improve their performance metric.

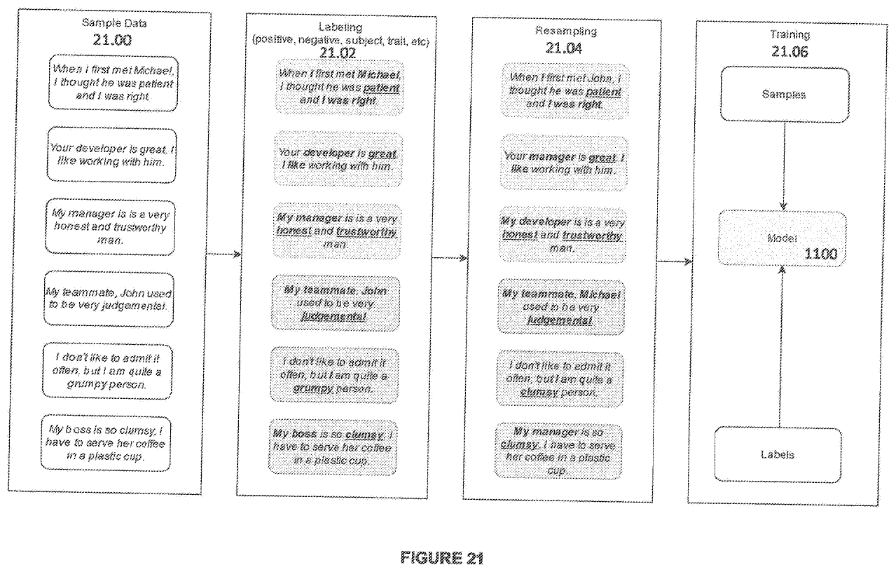

Referring now generally to the Figures, and particularly to FIG. 21, FIG. 21 is a diagram providing further detail regarding the training process of FIG. 17, including example training data. In the training context 17.00, first the set of sample data 21.00 is provided. It is noted that this might be an instance of the sample data 17.02 as presented in FIG. 17. Second, the sample data is labeled, in a labeling stage 21.02. It is noted that this might be an instance of the process of labeling 17.04 as presented in FIG. 17. This may be done by a human administrator or administrators, selecting relevant features from the sample data and indicating these features' significance. For instance, in the sample data provided, a human administrator may flag the word elements “great” and “trustworthy” as indicators that the speaker is making a positive statement, and the word elements “judgmental” and “grumpy” as indications that the speaker is making a negative statement. In a resampling stage 21.04 as presented here, the data may be resampled, producing further similar examples for the AI model to train with or test its algorithm on. In a training stage 21.06, the model is trained utilizing the sample data paired with the labeling.

It is noted that artificial intelligence algorithms as known and practiced generally in the art consist of processes such as deep learning and neural networking, wherein software is implemented by a computer to analyze pre-generated data (“training data”) and develop an algorithm to predict or identify similar content. A simple, generalist example of this might be a program for categorizing images of animals. The initial training data set might consist of hundreds or thousands of images (the more the better, generally) of animals, each labeled with that animal's name by a human administrator confident in their grade school education (i.e. animal identification skills). After the hundredth or thousandth image labeled ‘cat’, the algorithm might have identified certain characteristics of a bitmap image likely to contain a cat; whether these are the same characteristics a human might notice doesn't really matter, as long as the algorithm ‘copes’; that is, as long as the AI develops a system or set of criteria that works for reliably completing the task. It is noted that computers don't ‘think’ the way humans do, and our own ‘algorithm’ for identifying a cat (e.g. has pointy ears, four legs, a tail, etc.) is probably not an optimal approach for the computer; an AI might develop a different one better suited to the strengths of a computer, such as calculation. The human brain's strength of pattern recognition processing is a very difficult kind of processing for a computer to do or imitate, when a computer stores everything as ones and zeroes; contemporary computers are generally terrible at pattern matching, particularly compared to the human brain, and imitating or faking the kind of pattern matching the human brain does so easily is a lot of complicated predictive calculation for a computer. The computer might develop criteria a human wouldn't use or consider, such as proportional ratios of the animal's face, contrast patterns, the range of possible eye coloration, or a particular feature of the nose; things a human brain might not notice or find very helpful, but the computer's calculation algorithm does happen to find helpful. Once an initial set of training data has been processed by an algorithmic model being trained, the algorithmic model might be tested and further improved by providing of a second training data set with the labels removed but available to ‘check’ the computer's answer. The first round of training data might be compared to first showing an object to a student and stating what the object is so the student associates the object with the label; the second might be more like flash cards, showing just the object and asking the student to supply the label, or vice versa. The computer receives further feedback in the form of whether its responses to the ‘flash card’ training data are correct or incorrect. Once the computer model is proficient enough, this trained AI may be used in real world situations, and may still continue learning and receiving feedback, though not in as controlled a manner as that initial training. It is noted that this example might be generalized to any sort of pattern-matching task, beyond the trivial example of identifying cats. For instance, in the medical field AIs have been trained, on data labeled by doctors, to analyze X-ray images and identify broken bones, or to analyze tissue sample images and identify signs of cancer. Similarly, linguistic statements can be analyzed by word usage, grammar, and other context clues to discern patterns and trends of speech.

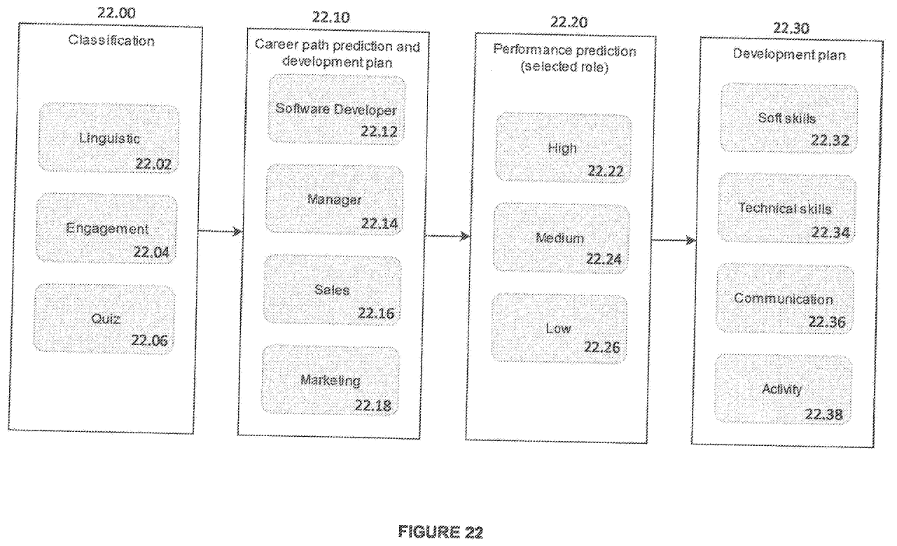

Referring now generally to the Figures, and particularly to FIG. 22, FIG. 22 is a diagram presenting steps of classifying possible or input data by type or origin, and matching those types of data to recommendations of career paths, predictions of performance, and suggestions for development. In a classification stage 22.00, the data may be classified by type, such as linguistic data 22.02, engagement data 22.04, or quiz data 22.06. In a career path prediction and development plan stage 22.10, some career path options might include software developer 22.12, manager 22.14, sales 22.16, and/or marketing 22.18. In a performance prediction stage, the user's performance in the selected role may be predicted, such as to produce a prediction of high performance 22.22, a prediction of medium performance 22.24, or a prediction of low performance 22.26. In a development plan stage 22.30, a development plan may be suggested or implemented regarding developing this user to perform well in a current role, an anticipated future role, or both, such as recommending a program for developing the user's soft skills 22.32 such as interpersonal skills, dependability, and teamwork; a program for developing the user's communication skills 22.34; a program for developing the user's technical skills 22.36; or a program for coaching the user in improving their measured results 22.38, such as suggesting that the user might participate more in office chats and emails to improve their performance metric.

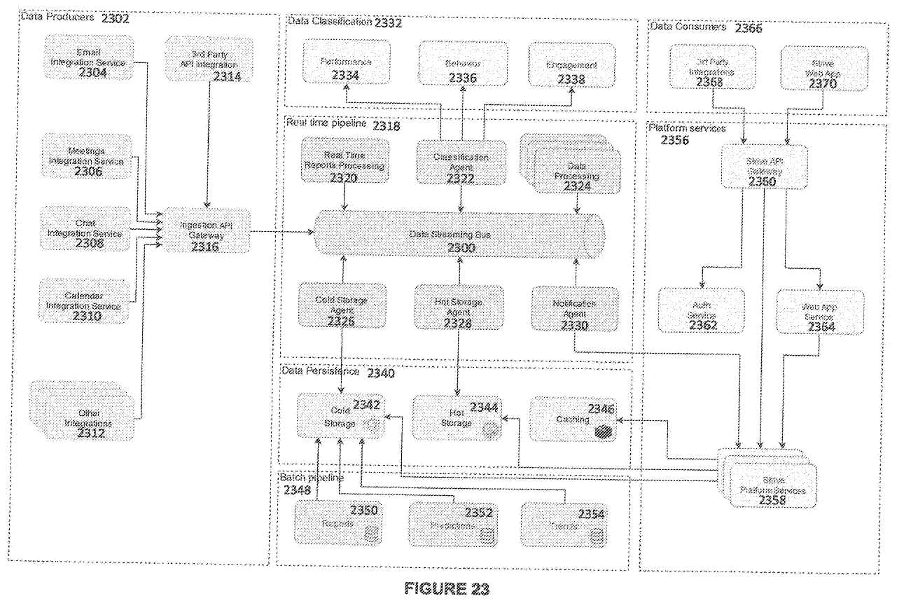

Referring now generally to the Figures, and particularly to FIG. 23, FIG. 23 is a diagram of aspects of the invented system, with attention to the connection pattern between various different elements in practicing the invented method. A data pipeline 2300, which may or may not be an instance of the AI model 1100, is interconnected to and with a plurality of data producers 2302, as well as classification algorithms, short-term and long-term memory, and services and users to which the data pipeline 2300 dispenses information. The data producers 2302 might include, but are not limited to, an email integration service 2304, a meetings integration service 2306, a chat integration service 2308, a calendar integration service 2310, other integration services 2312, and a 3rd party API integration 2314, all making these elements' gathered data available to the data pipeline 2300 via an ingestion API gateway 2316. The data pipeline 2300 itself is part of a real time pipeline 2318, which includes also a real time reports processing module 2320, a classification agent 2322, a plurality of data processing modules 2324, a cold storage agent 2326, a hot storage agent 2328, and a notification agent 2330. The classification agent 2322 interfaces between the data pipeline 2300 and a data classification module 2332 further subdivided into a performance categorization algorithm 2334, a behavior categorization algorithm 2336, and an engagement categorization algorithm 2338. The cold storage agent 2326 and the hot storage agent 2328 interface with a plurality of data persistence modules 2340 further comprising at least a cold storage module 2342, a hot storage module 2344, and a caching module 2346. The cold storage module 2342 is further connected to a batch pipeline module 2348 including at least a reports module 2350, a predictions module 2352, and a trends module 2354. Additionally, a plurality of platform services 2356, including Strive platform services 2358, a Strive API gateway, an authentication service 2362, and a web app services 2364 access the plurality of data persistence modules 2340 and the notification agent 2330, making the data pipeline 2300 network and data available to a plurality of data consumers 2366 such as a 3rd party integration(s) 2368 and a Strive web app 2370.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

We claim:

1. A method comprising:
deriving a first performance score from an individual's behavior;
selecting a behavioral cue associated with the first performance score;
determining a time to communicate the behavioral cue at least partially in view of a foreseen behavioral opportunity; and
communicating to the individual the behavioral cue via a communications network at the time determined.

2. The method of step 1, further comprising:
observing the individual's behavior after communicating the behavioral cue to the individual; and
deriving an updated performance score at least partially on the basis of the first performance score and the observing of the individual's behavior after communicating the behavioral cue to the individual.

3. The method of claim 1, wherein deriving the first performance score comprises analyzing electronic messaging generated by the individual.

4. The method of claim 3, wherein deriving the first performance score further comprises analyzing electronic messaging generated by the individual and other parties, wherein the messaging generated by other parties is communicated to the individual.

5. The method of claim 1, wherein deriving the first performance score comprises analyzing measurements of physical behavior of the individual.

6. The method of claim 5, wherein deriving the first performance score further comprises analyzing electronic messaging generated by the individual.

7. The method of claim 6, wherein deriving the first performance score further comprises analyzing electronic messaging generated by the individual and other parties, wherein the messaging generated by other parties is communicated to the individual.

8. The method of claim 1, wherein the behavioral cue is communicated to the individual as a textual message.

9. The method of claim 1, wherein the behavioral cue is communicated to the individual as visually rendered data selected from image data group consisting of graphic data, photographic data, animation data, and illustration data.

10. The method of claim 1, wherein the behavioral cue is communicated to the individual as a vibration.

11. The method of claim 1, wherein the behavioral cue is communicated to the individual as an audible sound.

12. The method of claim 1, further comprising rendering the behavioral cue to the individual from a content message consisting of text data, graphic data, haptic data, and sound data.

13. A method comprising:
deriving an online performance score from an individual's interaction with and information technology system;
selecting a behavioral cue associated with the online performance score;
determining a time to communicate the behavioral cue at least partially in view of a desired performance metric; and
communicating to the individual the behavioral cue via a communications network at the time determined.

14. The method of claim 13, wherein the desired performance metric is at least partially derived from a human performance model.

15. The method of step 14, wherein the human performance model is personalized on the basis of observing the individual's behavior.

16. The method of step 14, further comprising:
observing the individual's behavior after communicating the behavioral cue to the individual; and
personalizing the human performance model on the basis of a first performance score and the observing of the individual's behavior after communicating the behavioral cue to the individual.

17. The method of claim 16, wherein deriving the first performance score further comprises analyzing electronic messaging generated by the individual.

18. The method of claim 17, wherein deriving the first performance score comprises analyzing electronic messaging generated by the individual and other parties, wherein the messaging generated by other parties is communicated to the individual.

19. The method of claim 13, further comprising rendering the behavioral cue to the individual from a content message consisting of text data, graphic data, haptic data, and sound data.

20. A database management system, comprising:
a processor bi-directionally communicatively linked with a communications network; and
a memory communicatively coupled with the processor and storing a database management system adapted to update a first database, the first comprising a plurality of nodes connected by edges, and the memory further storing executable instructions that, when executed by the processor, perform operations comprising:
derive a first performance score from an individual's behavior on the basis of performance received via the communications network;
select a behavioral cue associated with the first performance score;
determine a time to communicate the behavioral cue at least partially in view of a foreseen behavioral opportunity; and
communicate to the individual via the communications network the behavioral cue at the time determined.

21. The database management system of claim 20, wherein the database comprises a database type selected from the database group consisting of a graph database, an in-memory database, a main memory DBMS database, and a memory resident database.
